(19) United States
(12) Patent Application Publication
(10) Pub. No.: US 2017/0211241 A1
(43) Pub. Date: Jul. 27, 2017

(54) De-Icing Paving Tile

(71) Applicants: Theodor Calinescu, Toronto (CA); Jonathan Marcus, Toronto (CA)

(72) Inventors: Theodor Calinescu, Toronto (CA); Jonathan Marcus, Toronto (CA)

(21) Appl. No.: 15/002,800

(22) Filed: Jan. 21, 2016

(51) Int. Cl. E01C 11/24; E01C 5/00; E01C 9/08; H05B 3/26; H05B 3/14

(52) U.S. Cl. CPC E01C 11/245; H05B 3/267; H05B 3/14; E01C 9/08; E01C 5/005; H05B 2214/02

(57) ABSTRACT

Herein is disclosed a ground tile for melting snow and ice. The ground tile includes a flat housing having upper and lower walls and opposite sides, the upper and lower walls and opposite sides defining an interior space. The ground tile also includes first and second electrodes disposed in the interior space, the first and second electrodes being spaced apart accordingly from one another. The interior space is filled with an aqueous glycol solution, the aqueous glycol solution being configured to heat up by electric resistance when an AC current is applied between the first and the second electrodes.

### CROSS REFERENCE TO RELATED APPLICATION

This application claims priority from U.S. provisional patent application 62/105,930 filed Jan. 21, 2015, the entirety of which is incorporated herein by reference.

### BACKGROUND OF THE INVENTION

Paving tiles which can be heated so as to melt any snow or ice deposited there on have been available for some time. These paving tiles generally include an electrical heating element imbedded within the tile, the heating element generally consisting of an elongated metal wire which heats up when electric current is passed through the wire. The electrical heating element generally heats up the surrounding portions of the tile, which in turn melts the ice or snow overlaying the tile.

While electricity heated tiles of this sort are effective in maintaining an ice free walk way or path, the use of electrical heating elements comprised of metal wires has its drawbacks.

Firstly, and most significantly, these type of heating elements results in uneven heating of the tile, resulting in spots where the tile is hotter than required and parts of tile which is cooler than required. As a result of this uneven heating, more electricity is utilized to ensure that all of snow is melted.

A system which provides a more uniform heating of the tile would therefore provide a more effective and energy efficient de-icing paving tile and the present detailed invention outlines this by using electricity but, it can be utilized by using solar panels, batteries or other “renewable” energy.

### SUMMARY OF THE PRESENT INVENTION

In accordance with one aspect of the present invention, there is provided a ground tile for melting snow and ice. The ground tile includes a flat housing having upper and lower walls and opposite sides, the upper and lower walls and opposite sides defining an interior space. The ground tile also includes first and second electrodes disposed in the interior space, the first and second electrodes being spaced apart accordingly from one another. The interior space is filled with an aqueous glycol solution, the aqueous glycol solution being configured to heat up by electric resistance when an AC current is applied between the first and the second electrodes.

With the foregoing in view, and other advantages as will become apparent to those skilled in the art to which this invention relates as this specification proceeds, the invention is herein described by reference to the accompanying drawings forming a part hereof, which includes a description of the preferred typical embodiment of the principles of the present invention.

### DESCRIPTION OF THE DRAWINGS

FIG. 1 is an isometric exploded view of four de-icing paving tiles made in accordance with the present invention.

FIG. 2 is isometric view of the shell assembled of one of the de-icing paving tiles made in accordance with the present invention showing the internal electrodes.

FIG. 3 is an isometric view of the electrodes shown in FIG. 2.

FIG. 4 is an exploded view of the shell made of two halves shown in FIG. 2.

FIG. 5 is a cross sectional view of a tile made in accordance with the present invention, showing the lock connector.

FIG. 6 is an exploded view of a single tile showing three lock connectors.

FIG. 7 is an exploded view and sections of the lock connector assembled with disk springs and “O” rings.

FIG. 8 is a bottom view of four tiles made in accordance with the present invention showing the means of interlocking the tiles together and lock and unlock positions.

FIG. 9 is an exploded view of the shell and ground sheath made in accordance with the present invention.

FIG. 10 shows four tiles and a section though the lock and labyrinth made according to the present invention.

In the drawings like characters of reference indicate corresponding parts in the different figures.

### DETAILED DESCRIPTION OF THE INVENTION

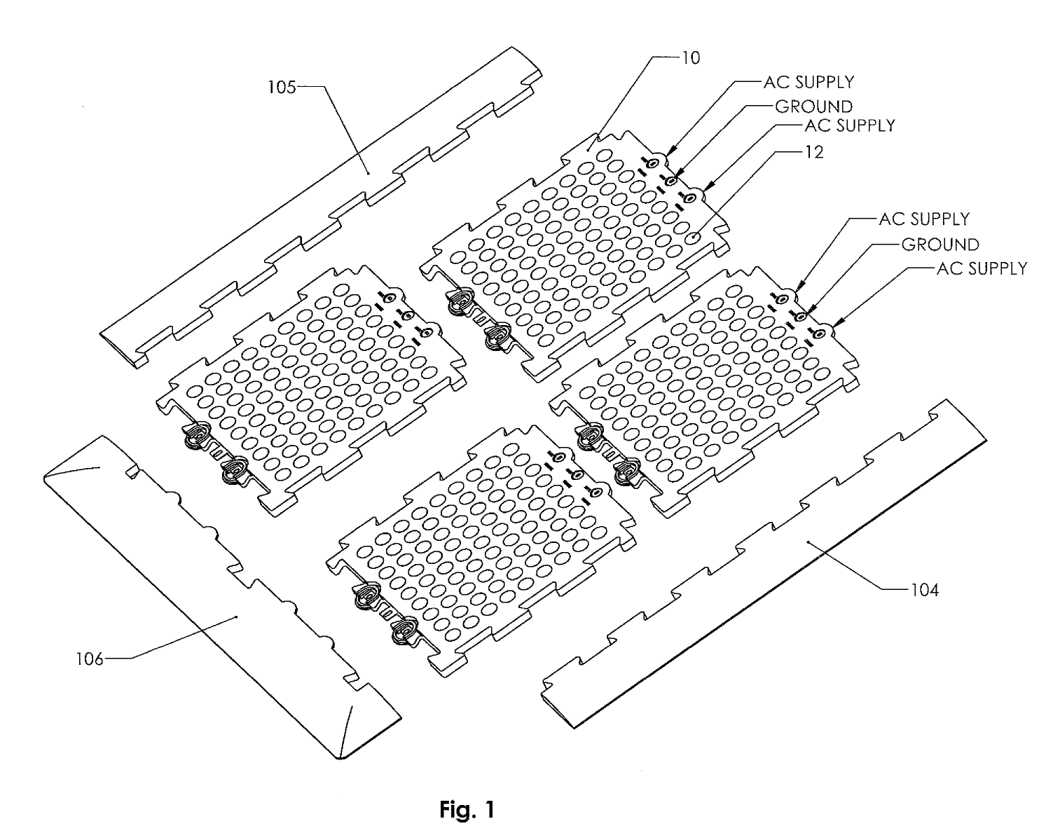

Referring firstly to FIG. 1, an array of heating tiles, shown generally as one, can be used to pave an area of ground. The array consists of a plurality of de-icing tiles 10, each being a square tile having four opposite sides which are configured to interlock with an abutting side on an adjacent tile. A plurality of convex profiles 12 are formed in each top surface of the tile to avoid slipping, any size or shape tile could be used, but in present invention is chosen a square tile.

On a complete set of tiles to cover the required ground, driveway or walkway and steps, the sides and the ends are protected with a plurality of the kick bars, 104, 105 and 106, shown on FIG. 1.

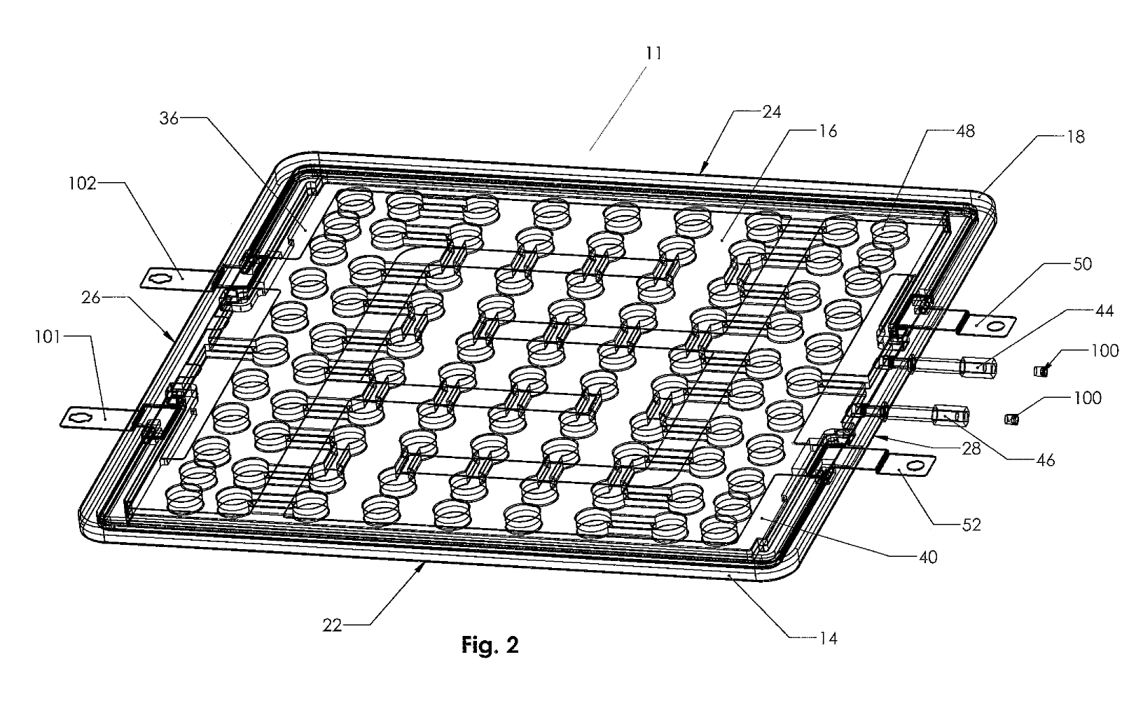

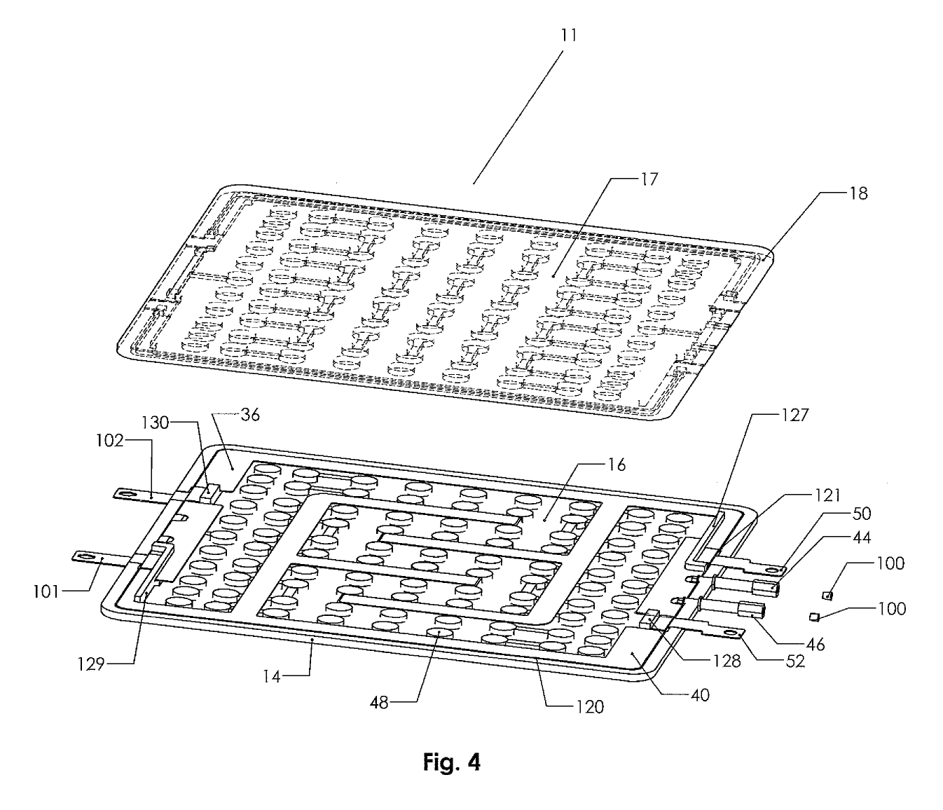

Each de-icing tile consists of a shell 11 which is over molded with a tough and resilient polymer. At best seen in FIGS. 2 and 4, the core portion of each tile consists of a bottom half of the shell 14 containing an interior 16 defined by top half shell wall 18 containing an interior 17, opposite sides 22 and 24 and opposite sides 26 and 28. The 14 and 18 shell halves could be identical, as shown, or otherwise.

Electrodes 40 and 36 are positioned in the interior space between 16 and 17 interior of each half shell. Electrode 40 is identical with electrode 36, or otherwise and rotated 180 degrees to each other inside adjacent sides 22, 24, 26 and 28. Fittings 44 and 46 are positioned on the side 28 and provide a means for filling interior 16 and 17 with aqueous and glycol and plugged with 100. Electrode connector 50 is coupled to electrode 36 and electrode connector tab 52 is coupled to electrode 40, both tabs project outside middle where the shell splits.

Electrode connector 102 is coupled to electrode 36 and electrode connector tab 101 is coupled to electrode 40, both tabs project outside middle where the shell splits.

FIG. 2 shows a water tight shell and a plurality of support columns 48, part of each half of the shell and sealed together and act to strengthen the structure from external load.

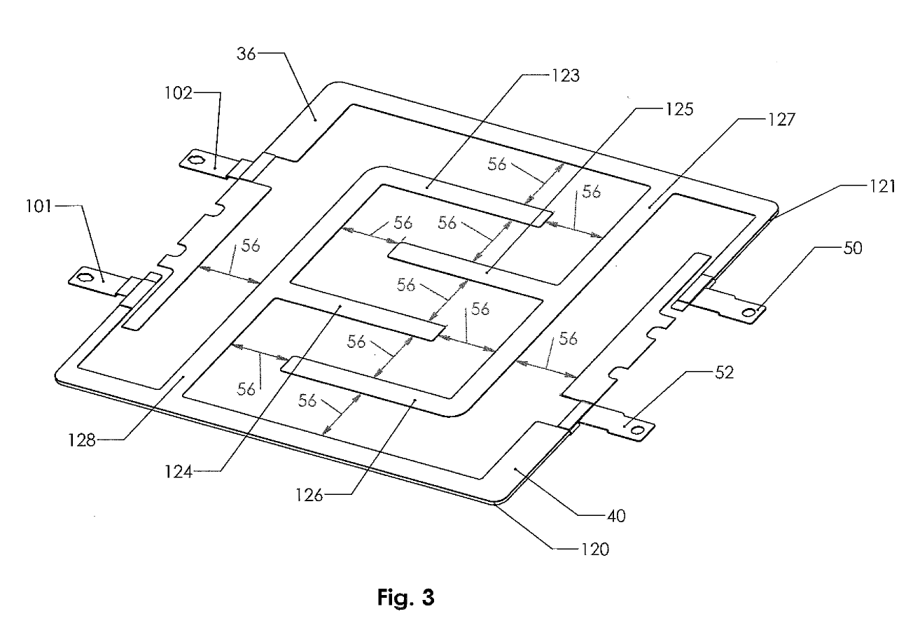

Electrode connectors 50 and 52 are for input AC and 101 and 102 are receiving power through the electrode and a good conductivity wire 120 and 121, FIG. 3, to avoid resistivity of the electrodes, to power the next tile.

Electrode 40 has an external wire frame 120 which is connected to tab 52 one end and to tab 101 at the other end. Electrode 36 has external wire frame 121 which is connected to tab 50 at one end and tab 102 at the other end. Convolutions 128, 124 and 123 are extensions of electrode 40 (see FIG. 3). Convolutions 127, 125 and 126 are extensions of electrode 36 (see FIG. 3).

Interior 16 and 17 is filled with electrically conductive aqueous and glycol solution, or similar solute.

The aqueous and glycol solution must contain a sufficient concentration of electrolytic to avoid freezing solute to permit the solution to carry an AC between electrodes 36 and 40. Referring now to FIG. 3, electrodes 36 and 40 have convolutions as described above. The convolutions of electrode 36 are interlaced with the convolutions of electrode 40 such that a substantially fixed distance 56 is maintained between all portions of electrodes 36 and 40. Because of the distance 56, electrical current is conducted between portions 124 and 126, 124 and 125, between 123 and 125, between 126 and 40, 125 and 128, 126 and 128, 123 and 127, and between 123 and 36, between 127 and 40 and between 128 and 36, essentially the entire interior of the tile is electrically heated in an uniform fashion. Since the electrodes are placed at distance 56, the electrical current passing through the aqueous and glycol solution is substantially uniform through interior 16 and 17. The aqueous and glycol solution essentially acts as an electrical resistance heating element and heats up as the electrical current flows through the solution. This results in substantially uniform heating of the entire core. FIG. 4 shows an exploded view of the shell 11.

The electrodes 36 and 40 have insulator blocks 127, 128, 129 and 130, in the areas where they are very close, mainly to avoid overheating because of proximity of the other electrode.

The concentration of aqueous and glycol solution filling the interior of the tile core is important. The concentration should be selected to insure that there is sufficient electrical conductivity to heat the solution at an appropriate rate to ensure melting of ice or snow overlaying the tile (not shown). Also, to ensure that the aqueous and glycol solution in the tile does not freeze, the aqueous and glycol solution should be sufficiently high. It has been discovered that approximately 30% of glycol in aqueous solution is sufficient to keep the solution liquid in subzero winter weather, while at the same time being sufficiently conductive to provide sufficient heat to melt snow and ice when current is applied.

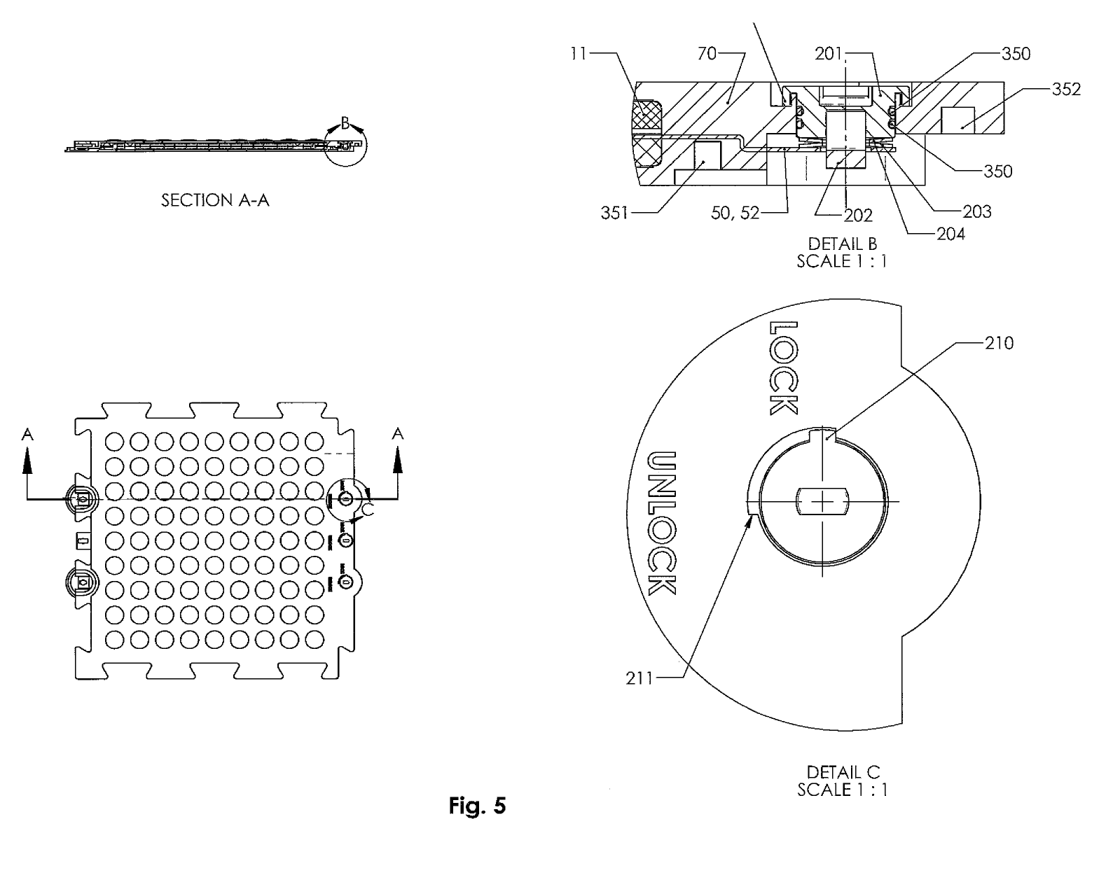

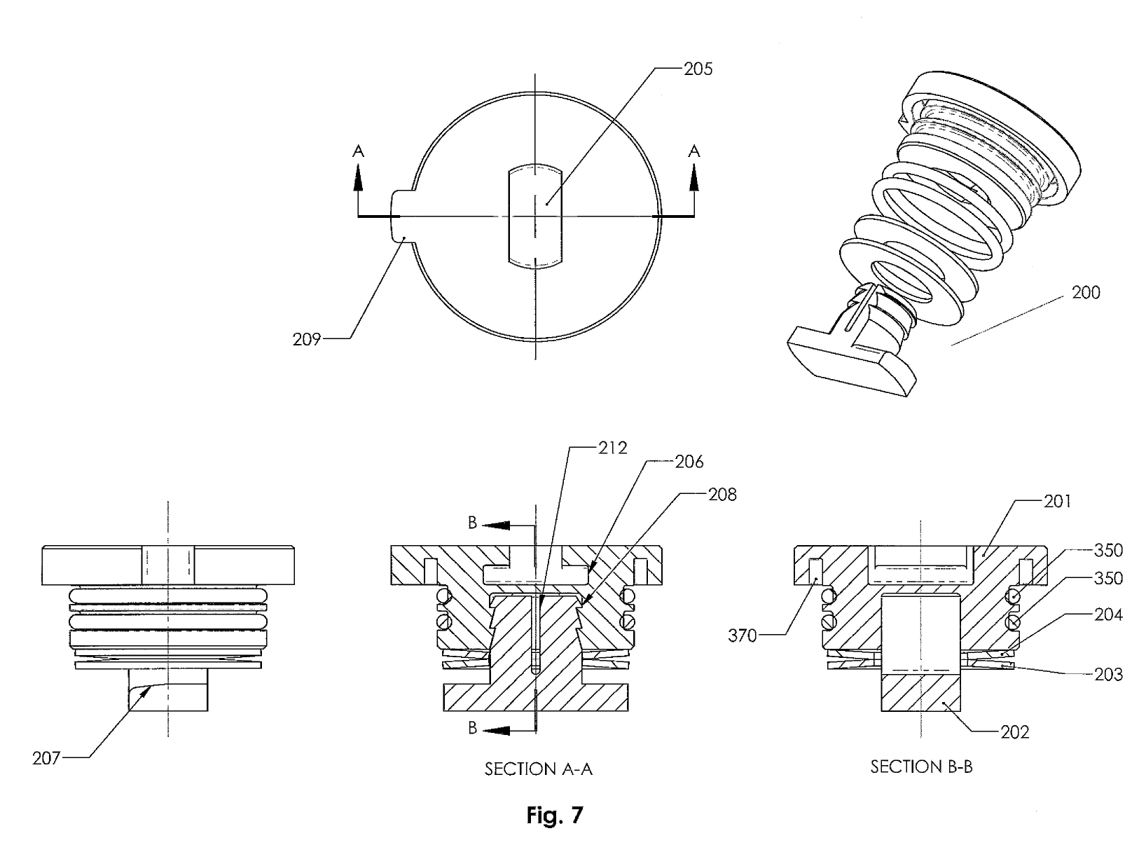

FIG. 5 shows the lock and unlock positions. The side where the locks 200 (FIG. 7) are placed is used to feed the tile from a busbar (FIG. 1) and also to power the next tiles on the row. The assembly will require to place the tile with electrode connectors with lock assembly 200 unlocked over connector tabs 101 and 102 and lock them to secure the AC flow.

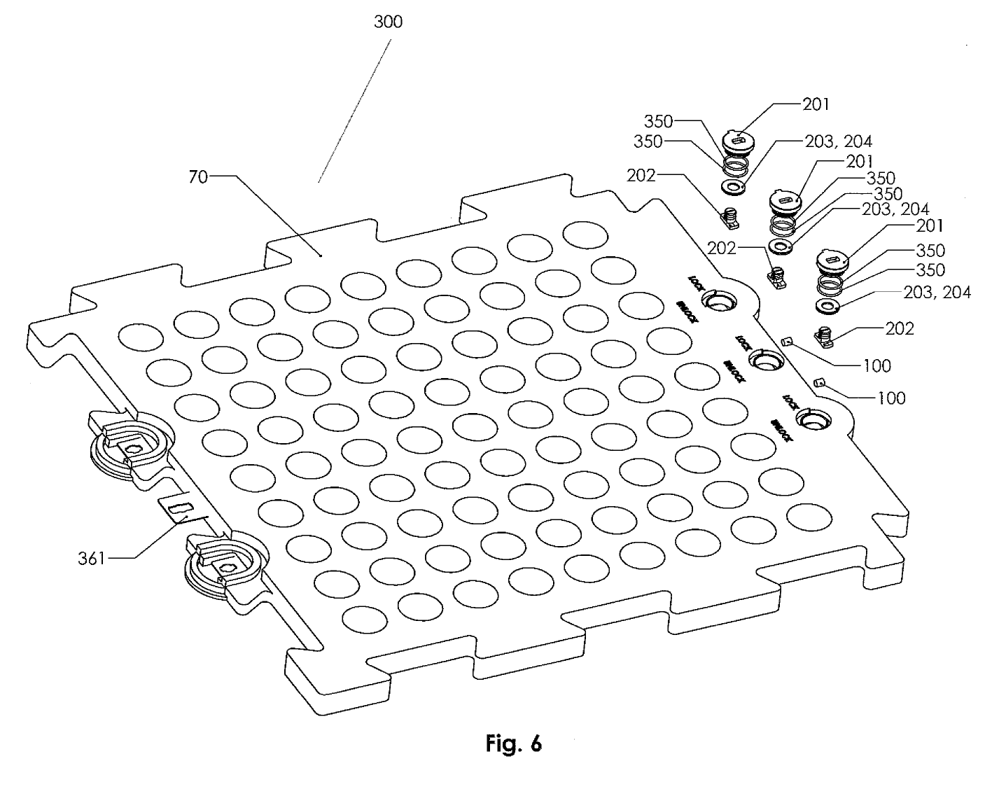

As mentioned above, the tile consists of inner shell 11 and an outer sheathing 70, FIG. 6, which is over-molded onto the shell. The shell is preferably formed as an upper and lower shell half which is then brought together and fused (sealed) after the insertion of the electrodes 36 and 40, wire 120 and 121 and electrode connectors 50, 52 and 101 and 102 and fittings 44 and 46.

Electrode connectors 50, 52, 101 and 102 and fittings 44 and 46 will project out of inner shell 11 and through sheathing 70 to make electrical circuit between two or more adjacent tiles possible. Also, fittings 44 and 46 will project out of inner shell 11 and through non-metal sheathing 70 to be able to fill up the interior of the tile with aqueous and glycol solution and plugged with 100, FIG. 2.

As mentioned above, support columns 48 are part of each half of the shell and sealed together to take the external loads, such as cars. The columns 48 help to support the tile and prevent the upper and lower walls from collapsing when pressure is applied to the tile.

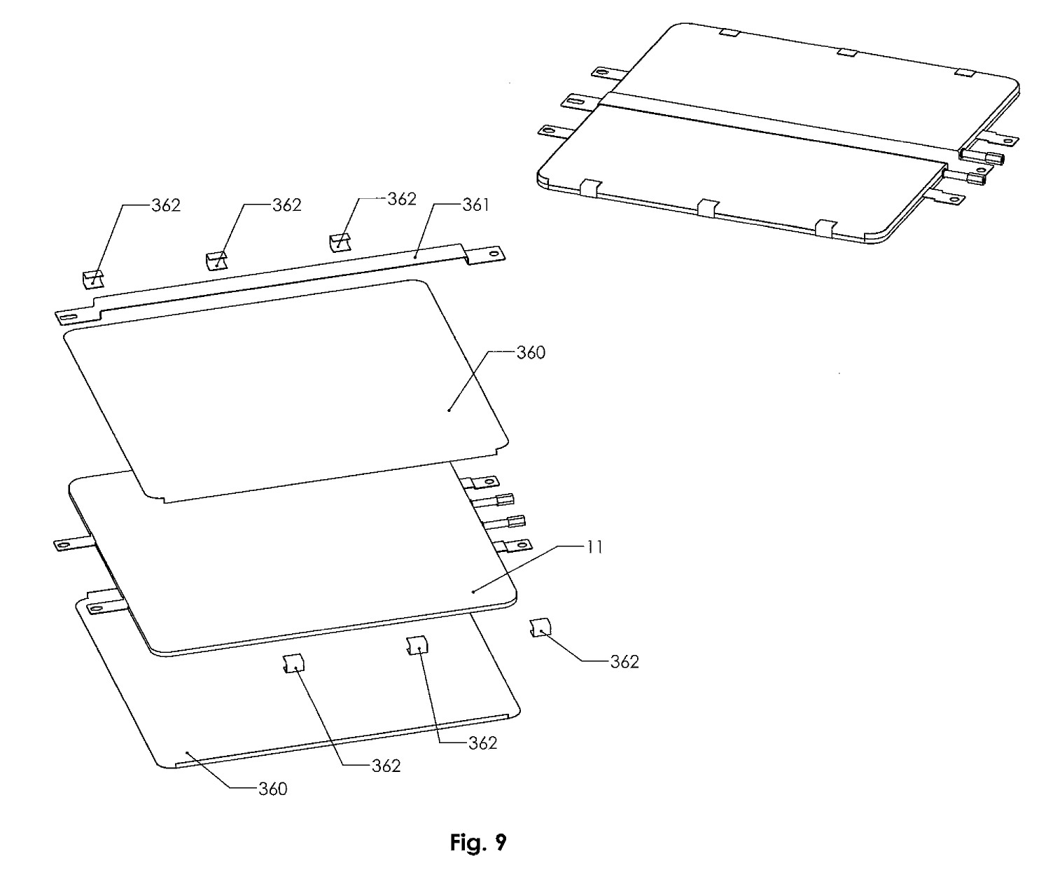

The three lock assemblies 200, FIGS. 5, 6 and 7, consists of a barrel 201, “T” lock shaft 202 and to secure electrical contact, the disk springs 203 and 204 will tighten the electrode connector tabs 50 with 102 and 52 with 101. The tapered portion 207 of “T” lock 202 will get engaged on the bottom portion of the connectors 101, 102 and 361 and lock. The third lock assembly 200 will be used to secure the ground contact between ground bars 361 on both ends and the metal sheath 360, top and bottom, FIG. 9.

Both metal sheaths 360, top and bottom, are covering the shell 11 and kept together with “U” metal brackets 362 and the metal ground bar on top 361, FIG. 9 and the assembly of 360, 361 and 362, will form a metal sheath and will be enveloped into non-metal sheath 70.

The lock assembly 200 is made of non-conducting material.

To rotate barrel +/−90 degrees 201 and “T” lock shaft 202 together, a slot 205 is provided. To remove the tile when the lock is in unlock position a circular profile 206 is provided, FIG. 7, using a tool (not shown).

To prevent water to reach the electrode connectors 50, 52, 101 and 102, there are two “O” ring seals 350 mounted on the barrel 201 grooves and when mounted will seal into the holes of sheath 70, FIGS. 6, 7 and 10. Also, a labyrinth 370 is provided on the barrel 201, FIGS. 5, 7 and 10 which will get engaged with the labyrinth in sheath 70.

The lock assembly 200 is placed first in the round holes of the electrode connector tabs 50, 52 and 361 as follows: the “T” lock shaft 202, disk springs 203 and 204 and “O” rings seals 350 on a complete tile 300, FIG. 6, and barrel 201 is pressed over “T” lock shaft 202 and the barbed profile 208 inside 201 and outside 202 will get engaged and secured, FIGS. 5 and 6. The slot 212 inside “T” lock shaft will allow the shaft to collapse at the insertion. The barrel tab 209 will limit the rotation of locking assembly in the tile against 210 to lock and 211 to unlock.

At the assembly of tiles, the “T” lock shaft will be in the unlock position and will go on top of the busbar or next tile and insert into the slots placed into electrode connector tab 101, 102 and 361 and lock.

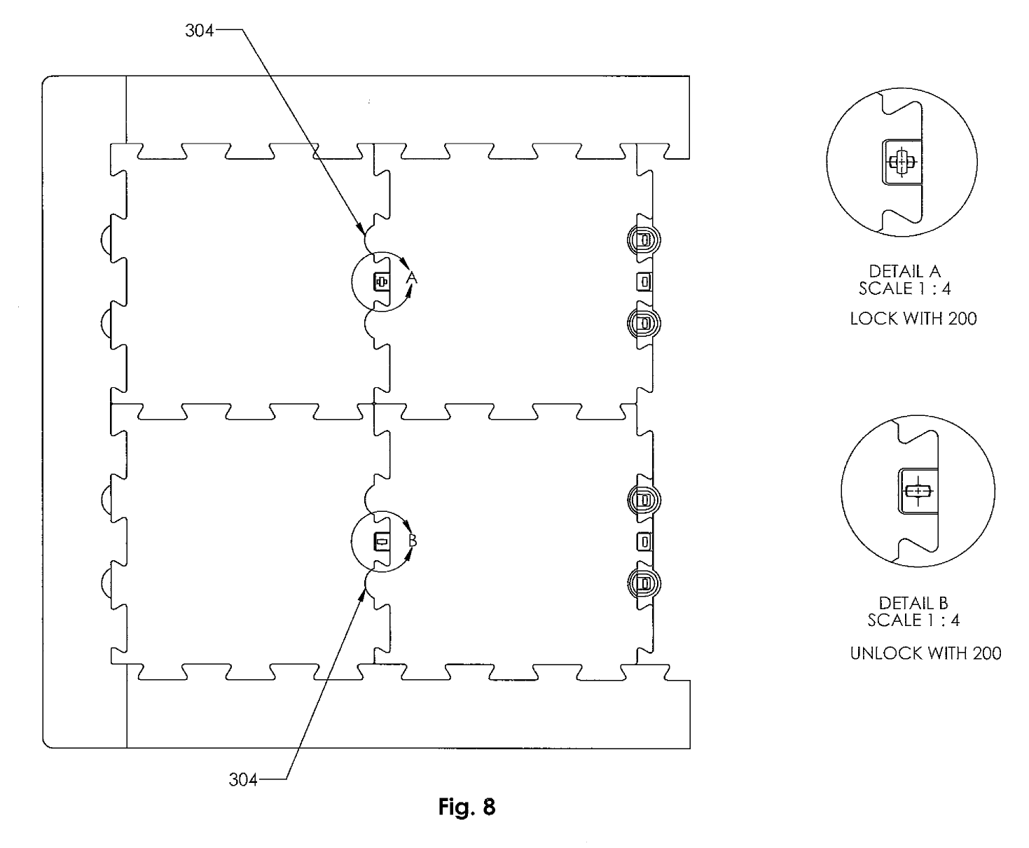

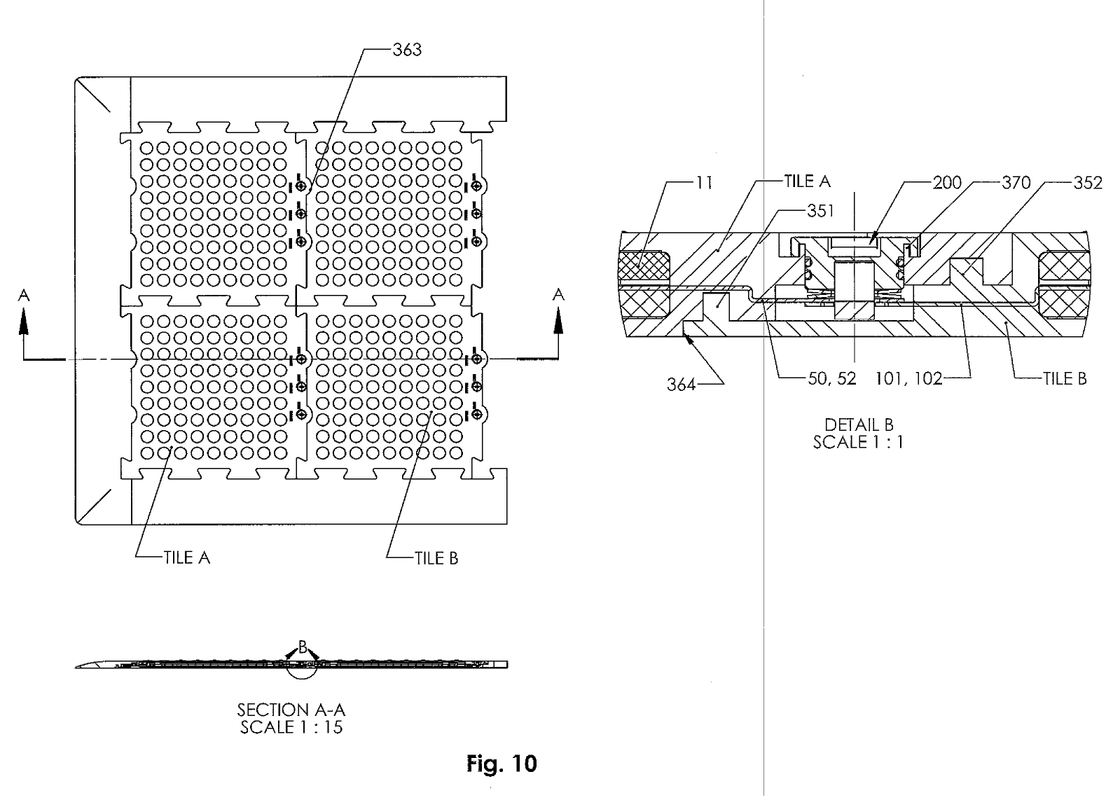

To prevent water to reach the electrode connectors through the contact profile 363 on the top side of the tiles, FIG. 10 and through the contact profile 364 on the bottom of the tile, FIGS. 5, 8 and 10, a labyrinth 351 and 352 is provided, in accordance with present invention.

The present invention has many advantages over the prior art. In particular, the use of the aqueous and glycol solution results in a very even heating of the tile. Also, the concentration of the aqueous and glycol solution can be selected to adjust the heat output of the tile without having to change the electrodes. Adjusting the concentration of the glycol in the solution also helps to prevent freezing of the solution in situations where the temperature of the environment will be exceptionally low. The tiles can be laid out in multiple configurations to accommodate the shape of the ground. The location of the electrode tabs can be selected to be on either the right or left sides to electrically connect adjacent tiles. The shape of the tiles need not be square and can be in any appropriate shape as required for the specific layout.

The tiles, either individually or in groups can be coupled to an external control module having a PLC (or similar) controller coupled to temperature and snow precipitation sensors. The control module can be preprogrammed to optimize the consumption of AC current dependant on the outside temperature and whether or not it is snowing, decreasing the current used when the temperature is high or where there is no snow falling. The external metal sheathing of the tiles can also be coupled to the ground circuit of the control module and the control module can be further configured to shut off the AC current in the event of a leak in the tiles or water infiltration in the external electrodes coupling one tile to another.

As the tiles are preferably used to pave driveways, walkways and steps, illumination may be provided in the tiles, such as the use of fluorescent or luminous barrels 201 (or other components).

Therefore, what is claimed is:

1. A ground tile for melting snow and ice, the ground tile comprising:
a. A flat housing having upper and lower walls and opposite sides, the upper and lower walls and opposite sides defining an interior space;
b. A first electrode and second electrode disposed in the interior space, the first and second electrodes being spaced apart accordingly from one another;
c. The interior space being filled with an aqueous glycol solution, the aqueous glycol solution being configured to heat up by electric resistance when an AC current is applied between the first and the second electrodes.

2. The ground tile of claim 1 further comprising a plurality of support columns extending between the upper and lower walls.

3. The ground tile of claim 1 wherein the first and second electrodes have a first and a second series of convoluted portions, respectively, the first and second series of convoluted portions being interlaced with each other, the first and second electrodes being further configured such that first series of convoluted portions is continually separated from the second series of convoluted portions by a fixed distance selected such that the current between all portions of the first and second electrodes is constant when an AC current is applied between the first and second electrodes.

4. The ground tile of claim 3 further comprising a first and second fitting port formed in the housing for communicating with the interior space to permit the aqueous and glycol solution to be poured into the interior space and plugged.

5. The ground tile of claim 1 further comprising of a polymer sheathing surrounding the housing.

6. The ground tile of claim 1 wherein the ground tile is coupled to an external control unit for optimizing the AC consumption dependant on snow and temperature conditions.

7. The ground tile of claim 6 further comprising first and second external electrode connectors coupled to the first and second electrodes, respectively, and further comprising a non-conductive lock assembly for physically coupling two identical ground tiles to each other with the ground tiles being electrically coupled to each other via the first and second external electrodes.

8. The ground tile of claim 7 wherein the housing is covered by an outside surface and further comprising a metal sheath covering more than 90% of the outside surface of the housing, the metal sheath being in turn covered with a polymer sheathing, the metal sheathing being electrically coupled to a ground circuit of the external control unit, the external control unit being configured to shut down the AC current in the event of any leak of the aqueous glycol solution from inside the tile, the control unit being further configured to shut down the AC current in the event of any external water reaching the external electrodes.
